(19) United States
(12) Patent Application Publication
(10) Pub. No.: US 2011/0179655 A1
(43) Pub. Date: Jul. 28, 2011

(54) SLIP-ON PENCIL SHARPENER SYSTEM

(76) Inventor: Mark Lemieux, Sault St. Marie (CA)

(21) Appl. No.: 12/917,404

(22) Filed: Nov. 1, 2010

Related U.S. Application Data
(60) Provisional application No. 61/298,108, filed on Jan. 25, 2010.

(51) Int. Cl. B43L 23/00

(52) U.S. Cl. 30/454

(57) ABSTRACT

A pencil sharpener removably couplable to a non-mechanical pencil including: a body comprising an external volume having a conically-shaped inner volume; a steel blade cutter that is removable and replaceable and is received in a recessed portion within an outer face side of the body; a biasing clip attacher that permits removable attachment of the pencil sharpener onto objects including a clothing pocket, belt, or bookmark; a light to provide illumination, and a friction fit cylindrical stabilizer having a biasing slit and a closed end for receiving a proximate end of the non-mechanical pencil. Further, the body has an outer face side of the body with a hand-conforming contour providing an increased-efficiency shave-removing surface within the body to permit insertion of a distal end of the non-mechanical pencil.

### CROSS-REFERENCE TO RELATED APPLICATION

The present application is related to and claims priority from prior provisional application Ser. No. 61/298,108, filed Jan. 25, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

1. Field of the Invention

The present invention relates generally to the field of pencil sharpeners and more specifically relates to a slip-on pencil-sharpening device that removably attaches to a non-mechanical pencil.

2. Description of the Related Art

A pencil is a writing implement or art medium usually constructed of a narrow, solid pigment core inside a protective casing. The case prevents the core from breaking, and also from marking the user's hand during use. Typically, pencils create marks via physical abrasion, leaving behind a trail of solid core material (normally graphite) that adheres to a sheet of paper or other surface. They are noticeably distinct from pens, which dispense liquid or gel ink that stain the light color of the paper.

Most pencil cores are traditionally made of graphite mixed with a clay binder, leaving grey or black marks that can be easily erased. Graphite pencils are used for both writing and drawing, and the result is durable: although writing can usually be removed with an eraser, it is resistant to moisture, most chemicals, ultraviolet radiation and natural aging. When using traditional pencils, it is necessary to have a sharpener that is readily accessible for use when the pencil tip becomes dull. A pencil sharpener is a device for sharpening a pencil's writing point by shaving away its worn surface and its protective casing. Pencil sharpeners may be operated manually or by an electric motor.

Traditionally, a sharp blade is mounted in a recess on the largest side such that its sharp edge just enters the cone. The body of the sharpener is often ridged or grooved to make it easier to grip firmly. It has no moving parts—the tip of the pencil is inserted into the hole of the sharpener and twisted, while the sharpener is held motionless. The blade inside the sharpener shaves the wood of the pencil, thus sharpening the tip, while the shavings emerge through a slot along the blade edge. An important feature is a larger clearance hole at the end of the cone allowing sections of the pencil lead which break away to be removed with only minor inconvenience. Such sharpeners can be bare or enclosed in a container to collect the shavings. Enclosed sharpeners can be harder to clear in the event of a blockage. The base of such a sharpener is often made of aluminum, magnesium or hard plastic. Skill is needed to avoid breaking the tip of the pencil being sharpened. Prism sharpeners may also be used and are typically hand-cranked.

As known in the art, wooden pencils are required to be sharpened after repeated use due to the tip becomes dull which may prove to be an uncomfortable and time-consuming task. Additionally, the wood pencil may not be transported in a shirt or pants pocket without the chance of leaving a graphite residue behind. Even when a pencil clip is used to removably couple a pencil to the pocket of the user, graphite residue may still occur unless the pencil clip is used with a shirt pocket protector

Tradesworkers such as carpenters may wear gloves while working thereby making it difficult task for them to grasp a small sharpener and insert the pencil therein for sharpening purposes. Pencil sharpeners are typically stored separately from a pencil so when a non-mechanical pencil requires sharpening, locating a pencil sharpener is not always successful creating frustration and time loss. A more efficient method is needed.

Various attempts have been made to solve the above-mentioned problems such as those found in U.S. Pat. Nos. 3,980,114, 2,287,703, 5,599,123, 4,406,315, 5,367,777, and 6,574,875. This prior art is representative of pencil sharpeners. None of the above inventions and patents, taken either singly or in combination, is seen to describe the invention as claimed.

Ideally, a pencil-sharpening device should operate reliably, be user-friendly and be manufactured at a modest expense. Thus, a need exists for a reliable slip-on pencil sharpening system to be used in conjunction with a pencil and to avoid the above-mentioned problems.

### BRIEF SUMMARY OF THE INVENTION

In view of the foregoing disadvantages inherent in the known pencil sharpening device art, the present invention provides a novel slip-on pencil sharpening system. The general purpose of the present invention, which will be described subsequently in greater detail is to provide consumers with an efficient apparatus and method for sharpening a pencil. This device preferably clips directly onto a pencil for easy access of both devices. The apparatus effectively eliminates the need to search for a sharpener and further provides a convenient way to removably attach the pencil to a belt or pocket. Clipping the pencil to an individual will also substantially prevent the pencil or the sharpener from becoming lost. The device may be optionally outfitted with various logos and designs and is ideal for use as an advertising means. Carpenters, artists, and others will enjoy the functionality and simplicity this system provides.

The present pencil sharpener is removably couplable to an existing non-mechanical pencil device as disclosed herein and preferably comprises the following components: a body; at least one steel blade cutter; at least one biasing clip attacher; at least one light, and a friction fit cylindrical stabilizer. The body comprises an external volume having a conically-shaped inner volume. Further, the body may include an indicia surface (planar or non-planar). Further, the body has an outer face side comprising a hand-conforming contour providing comfort, ease of use and efficiency for its users (especially for the users that may have difficulty in manipulation because they are wearing gloves). This feature additionally provides an increased-efficiency shave-removing surface within the body to permit insertion of a distal end of the non-mechanical pencil.

Preferably the steel blade cutter is removable and replaceable. Further, the steel blade cutter is received in a recessed portion within an outer face side of the body, thereby providing stability and durability for in-use periods.

The biasing clip attacher is integral with the body and permits removable attachment of the pencil sharpener onto at least one object including a clothing pocket, belt, or permits the device to work as a bookmark. Additionally, the at least one light (LED or other) provides illumination for poor lighting conditions. The friction-fit cylindrical stabilizer comprises a biasing slit and a closed end for receiving a proximate end of the non-mechanical pencil. The pencil is rotatable inside the conically-shaped inner volume to create a sharpening of the distal end of the non-mechanical pencil for use.

A kit is embodied herein for the slip-on pencil sharpener device system comprising: a pencil sharpener; at least one logo; at least one replaceable steel blade cutter; at least one light, (LED of one or more colors); and a set of user instructions. The slip-on pencil sharpener device system may further comprise a match-mated pencil in certain embodiments.

In accordance with the embodiments of the present invention a preferred method of use is disclosed herein comprising: step one inserting a non-mechanical pencil(s) into a slip-on pencil sharpener; step two sharpening the non-mechanical pencil(s) using the slip-on pencil sharpener; and step three clipping the slip-on pencil sharpening system onto at least one object for ease of locating and transport.

The present invention holds significant improvements and serves as a slip-on pencil sharpener system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, slip-on pencil sharpener device constructed and operative according to the teachings of the present invention.

FIG. 1 shows a pencil being inserted into a slip-on pencil sharpening system according to an embodiment of the present invention.

FIG. 2 shows a perspective view illustrating the slip-on pencil sharpening system donned on a user according to an embodiment of the present invention.

FIG. 3 is a perspective view illustrating a slip-on pencil sharpener of the slip-on pencil sharpening system removably attached onto a book according to an embodiment of the present invention of FIG. 1.

FIG. 4 is a perspective view illustrating an LED light located on the slip-on pencil sharpener according to an embodiment of the present invention of FIG. 1.

FIG. 5. is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

As discussed above, embodiments of the present invention relate to a pencil-sharpening device and more particularly to slip-on pencil-sharpening device that removably attaches to a non-mechanical pencil.

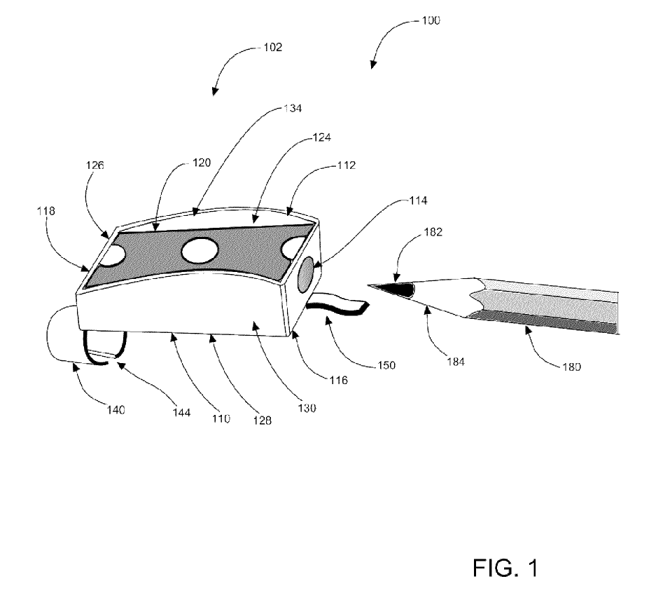

Referring now to FIG. 1 showing a perspective view illustrating slip-on pencil sharpening system 100. Slip-on pencil sharpening system 100 preferably comprises slip-on pencil sharpener 102. Slip-on pencil sharpener 102 offers an improved apparatus and method for sharpening non-mechanical pencil(s) 180. Slip on pencil sharpener 102 is removably coupleable to non-mechanical pencil(s) 180, as shown. Slip on pencil sharpener 102 within the particular embodiment shown comprises body 110, at least one biasing clip attacher 130; and friction fit cylindrical stabilizer 140.

Body 110 comprises external volume 112 and conically-shaped inner volume 114. Conically-shaped inner volume 114 is located within proximate end 116 of body 110. Conically-shaped inner volume 114 comprises a hollow region for the removable insertion of non-mechanical pencil(s) 180.

External volume 112 comprises steel blade cutter 120. Steel blade cutter 120 comprises a sharpening blade to shave the wood off of non-mechanical pencil(s) 180 and may comprise alloys or other materials sufficient to provide a durable cutting means. Steel blade cutter 120 is received in recessed portion 124 within outer face side 126 of body 110. When non-mechanical pencil(s) 180 is inserted and rotated inside conically-shaped inner volume 114, steel blade cutter 120 preferably sharpens distal end 184 of non-mechanical pencil(s) 180. When non-mechanical pencil(s) 180 is being sharpened, the shavings preferably emerge through a slit along a blade edge. It should be noted that the term non-mechanical pencil 180 refers to pencils requiring sharpening to maintain a fine writing point.

Steel blade cutter 120 is preferably removable and replaceable within certain embodiments of the present invention. This feature provides that when the edges on steel blade cutter 120 become dull, user 170 may remove and replace steel blade cutter 120 with a new one, thereby allowing greater longevity of the device.

Outer face side 126 of body 110 within the embodiment shown in this figure preferably comprises hand-conforming contour 134. Hand-conforming contour 134 provides an increased-efficiency shave-removing surface due to a convex curvature of body 110. Slip-on pencil sharpener 102 may be comfortably grasped in a hand of user 170 due to hand-conforming contour 134 thereby requiring less rotation of slip-on pencil sharpener 102 when user 170 is sharpening non-mechanical pencil(s) 180. Additionally, the user-sharpener may push down on hand-conforming contour 134 (when placed on a planar surface) using gloves or other and still maintain a suitable gripping means whereby slip-on pencil sharpener 102 may be manipulated for use.

Inner-face side 128 of body 110 may comprise at least one indicia surface (preferably planar). Indicia surface may further comprise at least one logo(s) 130 for advertising means. Logo(s) 130 may include a graphic mark or emblem commonly used by commercial enterprises, organizations and/or individuals to promote public recognition. Logo(s) 130 may be either purely graphic (symbols/icons) such as a sports team or may also comprise the name of the entity. Slip-on pencil sharpener 102 may be manufactured in a variety of colors to accommodate preferences of user 170. Slip-on pencil sharpener 102 may also comprise rounded edges to effectively prevent snagging on clothing.

Non-mechanical pencil(s) 180 may be removably couplable to slip on pencil sharpener 102 via friction-fit cylindrical stabilizer 140. Friction-fit cylindrical stabilizer 140 may comprise biasing slit 144. Biasing slit 144 within this particular embodiment includes a long, straight, narrow cut or opening through the center of friction-fit cylindrical stabilizer 140 to permit slight flexibility when inserting non-mechanical pencil(s) 180 onto slip-on pencil-sharpener 102. In this way friction-fit cylindrical stabilizer 140 frictionally and securely receives proximate end of 186 non-mechanical pencil(s) 180 for efficient temporary storage and transport.

Friction-fit cylindrical stabilizer 140 may comprise a closed end (or substantially closed end) within certain embodiments of the present invention. When friction-fit cylindrical stabilizer 140 comprises a closed end, proximate end 186 of non-mechanical pencil(s) 180 is relative to the closed end while tip 182 (that may be sharpened) is projecting outward away from user 170 to prevent possible injury due to contact with the sharpened tip 182.

Further, friction-fit cylindrical stabilizer 140 may comprise a through-opening. When friction-fit cylindrical stabilizer 140 comprises the through-opening, non-mechanical pencil(s) 180 may be grasped and temporarily stored and transported on a user-chosen location on a shaft of non-mechanical pencil(s) 180. In this embodiment the device may be substantially secured to virtually any similarly sized tubular member such as a pen, mechanical pencil or other such object.

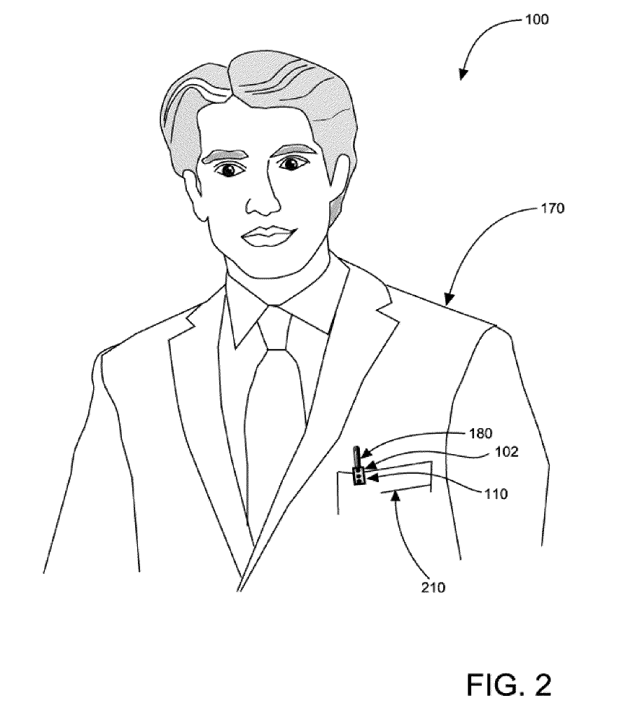

Referring now to FIGS. 2 & 3 showing perspective views illustrating slip-on pencil sharpener 102 removably attachable to at least one object according to an embodiment of the present invention. Slip-on pencil sharpener 102 is removably attachable to at least one object via at least one biasing clip attacher 150. Biasing clip attacher 150 includes a spring-clip arm (or other suitable securing means) that may project from and is integral with body 110 that permits removable attachment of slip-on pencil sharpener 102 to at least one object.

The at least one object that body 110 removably attaches to may comprise clothing pocket 210 on user 170 as shown in FIG. 2. When non-mechanical pencil(s) 180 is removably attached to slip on pencil sharpener 102 and removably couplable to clothing pocket 210, graphite from non-mechanical pencil(s) 180 is thereby substantially prevented from rubbing off onto clothing pocket 210 due to tip 182 not coming in direct contact with clothing pocket 210.

Further, objects may comprise book 310 allowing slip-on pencil sharpener 102 to operate in a bookmarking capacity as shown in FIG. 2. Additionally, objects may comprise a belt which may prove useful in the carpentry, architechtural, art, or construction industries.

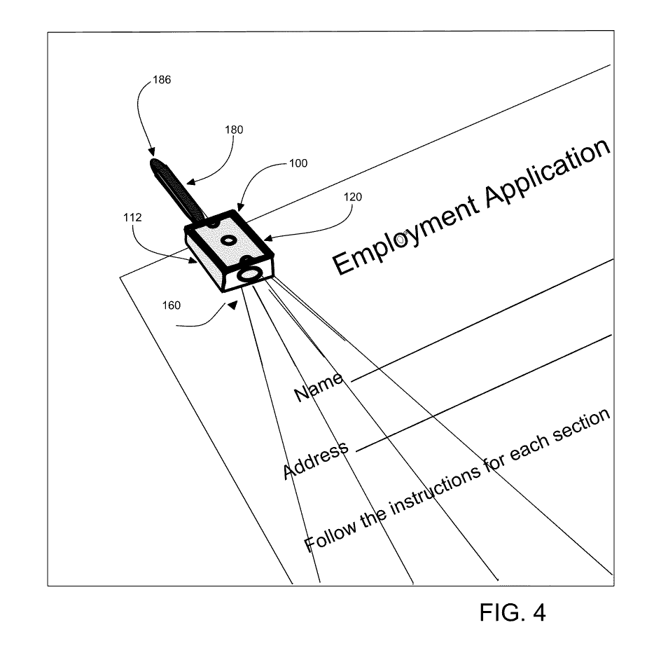

Referring now to FIG. 4, illustrating a perspective view illustrating LED light(s) 160 located in slip-on pencil sharpener 102 according to an embodiment of the present invention of FIG. 1. LED light(s) 160 is preferably located opposite conically-shaped inner volume 114 on distal end 118 of body 110. A light-emitting diode (at least herein embodying LED light(s) 160) is a semiconductor light source. LED light(s) 160 within the present invention are used as illumination means. Other lighting mechanisms such as a miniature incandescent bulb may also be used as an alternative to using LED light(s) 160. When LED light(s) 160 is used as the light source, LED light(s) 160 preferably emits white light. Illumination provided may be handy for instances where user 170 may wish to read or locate another object. In this way LED light(s) 160 provides illumination means in dim or dark areas to user 170. LED light(s) 160 may further include a shroud or other covering to prevent glare when user 170 is using LED light(s) 160 for reading purposes. Additionally, LED light(s) 160 may include a lens to permit user 170 to have focused and targeted illumination means on a relatively small region.

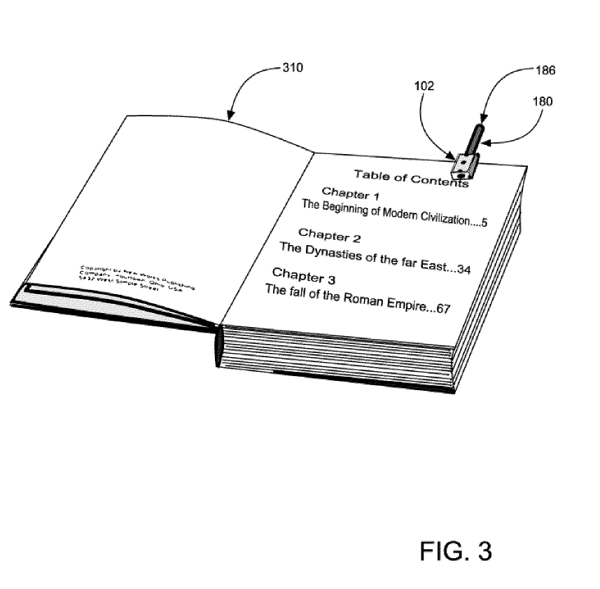

Slip-on pencil sharpener system 100 according to an embodiment of the present invention of FIGS. 1-4 may comprise kit 440. Kit 440 may comprise the following parts: slip-on pencil sharpener 102; at least one logo(s) 130; at least one replaceable steel blade cutter 120; a least one light(s) 160; and a set of user instructions. Slip-on pencil sharpener system 100 may further comprise a match-mated non-mechanical pencil(s) 180. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately such as pencil sharpeners, etc., may be sufficient.

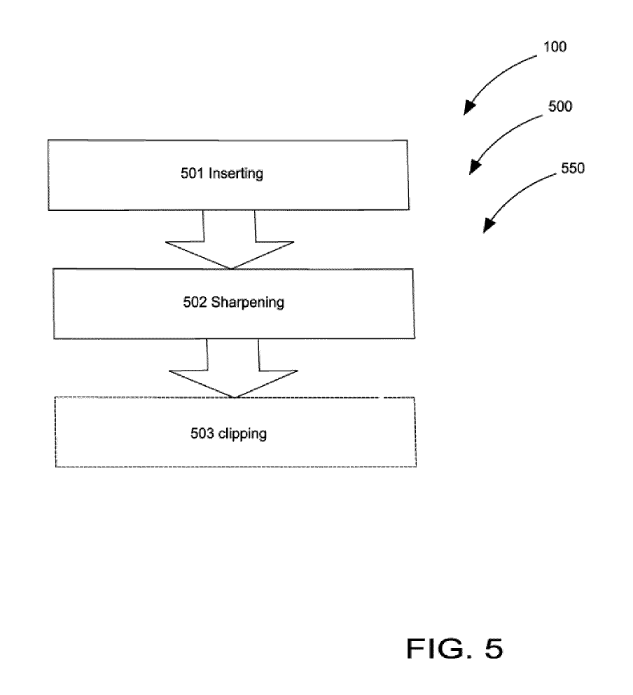

Referring now to FIG. 5. showing a flowchart 550 illustrating a method of use 500 according to an embodiment of the present invention of FIGS. 1-5. A method of using slip-on pencil sharpener device 102 preferably comprising the steps of: step one 501 inserting non-mechanical pencil(s) 180 into slip-on pencil sharpener 102; step two 502 sharpening non-mechanical pencil(s) 180 using slip-on pencil sharpener 102; and step three 503 clipping slip-on pencil sharpening system 100 onto at least one object. These steps may be repeated as required.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pencil sharpener removably couplable to a pencil, comprising:
a body having a conically-shaped inner volume within said body to permit insertion of a distal end of said pencil;
at least one steel blade cutter;
at least one biasing clip attacher integral with said body that permits removable attachment of said pencil sharpener onto at least one object; and
a friction-fit cylindrical stabilizer for receiving a proximate end of said pencil;
wherein said steel blade cutter is received in a recessed portion within an outer face side of said body;
wherein said pencil comprises a non-mechanical pencil; and
wherein said pencil is rotatable inside said conically-shaped inner volume to create at least one sharpening of said distal end of said pencil.

2. The pencil sharpener of claim 1 wherein said friction-fit cylindrical stabilizer comprises a closed end.

3. The pencil sharpener of claim 1 wherein said friction-fit cylindrical stabilizer comprises a through-opening.

4. The pencil sharpener of claim 1 wherein said body comprises an external volume and said outer face side of said body comprises a hand-conforming contour.

5. The pencil sharpener of claim 4 wherein said hand-conforming contour provides an increased-efficiency shave-removing surface.

6. The pencil sharpener of claim 4 wherein said body comprises at least one indicia surface.

7. The pencil sharpener of claim 1 further comprising at least one LED light suitable to provide illumination.

8. The pencil sharpener of claim 1 wherein said at least one object comprises a clothing pocket.

9. The pencil sharpener of claim 1 wherein said at least one object comprises a book allowing said pencil sharpener to operate in a bookmarking capacity.

10. The pencil sharpener of claim 1 wherein said at least one object comprises a belt.

11. The pencil sharpener of claim 4 wherein said at least one steel blade cutter is removable and replaceable.

12. The pencil sharpener of claim 1 wherein said friction-fit cylindrical stabilizer comprises a biasing slit.

13. A pencil sharpener removably couplable to a non-mechanical pencil, comprising:
a body comprising an external volume having a conically-shaped inner volume, at least one indicia surface, an outer face side of said body comprising a hand-conforming contour providing an increased-efficiency shave-removing surface and alternate holding means, said body permitting insertion of a distal end of said non-mechanical pencil;
at least one steel blade cutter that is removable and replaceable;
at least one biasing clip attacher integral with said body that permits removable attachment of said pencil sharpener onto at least one object including a clothing pocket, belt, or bookmark;
a least one light to provide illumination; and
a friction fit cylindrical stabilizer that comprises a biasing slit and a closed end for receiving a proximate end of said non-mechanical pencil;
wherein said steel blade cutter is received in a recessed portion within an outer face side of said body; and
wherein said pencil is rotatable inside said conically-shaped inner volume to create a sharpening of said distal end of said non-mechanical pencil.

14. The pencil sharpener of claim 13 further comprising a kit including: said pencil sharpener; at least one logo; at least one replaceable said steel blade cutter; a least one said light, said light being an LED; and a set of user instructions.

15. The pencil sharpener of claim 14 further comprising a match-mated pencil.

16. A method of using a slip-on pencil sharpening system comprising the steps of:
inserting a pencil into a removably attachable pencil sharpener;
sharpening said pencil using said removably attachable pencil sharpener;
clipping said pencil sharpening system onto at least one object.
